(19) United States
(12) Patent Application Publication
(10) Pub. No.: US 2014/0136332 A1
(43) Pub. Date: May 15, 2014

(54) PROVIDING SOCIAL CONTEXT FOR PRODUCTS IN ADVERTISEMENTS

(71) Applicant: Facebook, Inc., Menlo Park, CA (US)

(72) Inventors: Alon Amit, Los Altos, CA (US); Gregory Joseph Badros, Palo Alto, CA (US)

(73) Assignee: Facebook, Inc., Menlo Park, CA (US)

(21) Appl. No.: 13/676,445

(22) Filed: Nov. 14, 2012

(51) Int. Cl. G06Q 50/00

(52) U.S. Cl. CPC G06Q 50/01; G06Q 30/0269
USPC 705/14.66

(57) ABSTRACT

A social networking system provides a social plug-in that enables advertisers to utilize relevant social context information available for advertising purposes. An advertiser adds the social plug-in next to an ad, where the plug-in is provided with a list of items that are relevant to the ad. The social plug-in communicates with the social networking system to retrieve social context information to provide to a particular viewing user based on the list of items relevant to the ad. The social plug-in also communicates with the social networking system to determine placement of an overlay of the social context information over the ad. A social plug-in may also enable web publishers to allow the social plug-in to serve advertisements alongside other social networking system features, such as recommendations, comments and content sharing.

### CROSS REFERENCE TO RELATED APPLICATION

This application is related to “Personalizing a Web Page Outside of a Social Networking System with Content from the Social Networking System Determined Based on a Universal Social Context Plug-In,” U.S. patent application Ser. No. 13/563,623 filed on Jul. 31, 2012, which is hereby incorporated by reference in its entirety.

### BACKGROUND

This invention relates generally to social networking, and in particular to providing social context for products in advertisements.

In recent years, social networking systems have made it easier for users to share their interests and preferences in real-world concepts, such as their favorite movies, musicians, celebrities, soft drinks, hobbies, sports teams, and activities. Tools have been designed to create nodes on the social networking system that represent web pages that embody these real-world concepts on different domains external to the social networking system, such as products, brands, and websites.

At the same time, users of social networking systems have shared their interests and engaged with other users of the social networking systems by expressing their interests in these concepts on web pages on different domains external to the social networking system. The amount of information gathered from users is staggering—information describing interests in sports, music, movies, and the like. Social networking systems have lacked tools to enable advertisers of products to utilize this information in conjunction with their advertisements.

Specifically, the information available on social networking systems about users' interests has not been made available for use with advertisements. This information about users' interests and preferences, including a viewing user's connections' action, interests, and preferences that provide “social context” for a particular interest and preference for the viewing user, is very valuable to third-party developers that seek to influence users to click on ads, drive traffic, and increase engagement with their websites. However, existing systems have not provided efficient mechanisms of enabling social context information for use with advertisements.

### SUMMARY

A social networking system provides a social plug-in that enables advertisers to utilize relevant social context information available for advertising purposes. An advertiser adds the social plug-in next to an ad, where the plug-in is provided with a list of items that are relevant to the ad. The social plug-in communicates with the social networking system to retrieve social context information to provide to a particular viewing user based on the list of items relevant to the ad. The social plug-in also communicates with the social networking system to determine placement of an overlay of the social context information over the ad. A social plug-in may also enable web publishers to allow the social plug-in to serve advertisements alongside other social networking system features, such as recommendations, comments and content sharing.

### BRIEF DESCRIPTION OF THE DRAWINGS

FIG. 1 is high level block diagram illustrating a process of providing relevant social context with an advertisement for a viewing user of a social networking system, in accordance with an embodiment of the invention.

FIG. 2 is a network diagram of a system for providing relevant social context with an advertisement for a viewing user of a social networking system, showing a block diagram of the social networking system, in accordance with an embodiment of the invention.

FIG. 3 is high level block diagram illustrating a social context module that includes various modules for providing relevant social context with an advertisement for a viewing user of a social networking system, in accordance with an embodiment of the invention.

FIG. 4 is a flowchart of a process of providing relevant social context with an advertisement for a viewing user of a social networking system, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A social networking system offers its users the ability to communicate and interact with other users of the social networking system. Users join the social networking system and add connections to a number of other users to whom they desire to be connected. Users of social networking system can provide information describing them which is stored as user profiles. For example, users can provide their age, gender, geographical location, education history, employment history and the like. The information provided by users may be used by the social networking system to direct information to the user. For example, the social networking system may recommend social groups, events, and potential friends to a user. A social networking system may also enable users to explicitly express interest in a concept, such as celebrities, hobbies, sports teams, books, music, and the like. These interests may be used in a myriad of ways, including targeting advertisements and personalizing the user experience on the social networking system by showing relevant stories about other users of the social networking system based on shared interests.

A social graph includes nodes connected by edges that are stored on a social networking system. Nodes include users and objects of the social networking system, such as web pages embodying concepts and entities, and edges connect the nodes. Edges represent a particular interaction between two nodes, such as when a user expresses an interest in a web page about a particular model of digital camera for sale on an e-commerce website, such as a Panasonic LUMIX DMCG2K SLR Digital Camera for sale on Amazon.com. The social graph may record interactions between users of the social networking system as well as interactions between users and objects of the social networking system by storing information in the nodes and edges that represent these interactions. Custom graph object types and graph action types may be defined by third-party developers as well as administrators of the social networking system to define attributes of the graph objects and graph actions. For example, a graph object for a movie may have several defined object properties, such as a title, actors, directors, producers, year, and the like. A graph action type, such as “purchase,” may be used by a third-party developer on a website external to the social networking system to report custom actions performed by users of the social networking system. In this way, the social graph may be “open,” enabling third-party developers to create and use the custom graph objects and actions on external websites.

Third-party developers may enable users of the social networking system to express interest in web pages hosted on websites external to the social networking system. These web pages may be represented as page objects in the social networking system as a result of embedding a widget, a social plug-in, programmable logic or code snippet into the web pages, such as an iFrame. Any concept that can be embodied in a web page may become a node in the social graph on the social networking system in this manner. As a result, users may interact with many objects external to the social networking system that are relevant to a keyword or keyword phrase, such as “Justin Bieber.” Each of the interactions with an object may be recorded by the social networking system as an edge. By enabling advertisers to target their advertisements based on user interactions with objects related to a keyword, the advertisements may reach a more receptive audience because the users have already performed an action that is related to the advertisement. For example, a merchandiser that sells Justin Bieber t-shirts, hats, and accessories may target ads for new merchandise to users that have recently performed one of multiple different types of actions, such as listening to Justin Bieber's song “Baby,” purchasing Justin Bieber's new fragrance, “Someday,” commenting on a fan page for Justin Bieber, and attending an event on a social networking system for the launch of a new Justin Bieber concert tour. Enabling third-party developers to define custom object types and custom action types is further described in a related application, “Structured Objects and Actions on a Social Networking System,” U.S. patent application Ser. No. 13/239,340 filed on Sep. 21, 2011, which is hereby incorporated by reference.

Social context information, or “social context,” that is being presented to a target user may be defined as information recorded by the social networking system about an action performed by or in connection with another user of the social networking system with whom the target user has a connection in the social networking system. Social context information that is relevant to a particular advertisement being provided to a viewing user, such as an ad for a Panasonic LUMIX DMCG2K SLR Digital Camera for sale on Amazon.com, may include various types of social context information, such as a number of other users of the social networking system connected to a viewing user of the ad that are interested in the specific camera, the brand of the camera, the type of the camera, and/or Amazon.com. Social context information may also be weighted based on other information available about users of the social networking system, such as affinity scores for connected users, level of interaction with connected users, reputation scores for connected users, and so on. A score may be computed for each type of social context information that is relevant to an advertisement. The scores may be determined using a scoring model having weights as determined by the advertiser. A social context information item having the highest score may be selected for overlay on the advertisement. Further, user feedback may be used to train the scoring model used in selecting social context information items to be displayed over an advertisement. Machine learning, heuristics analysis, and regression analysis may be used in providing relevant social context information with respect to an advertisement displayed to a viewing user of a social networking system, as described herein.

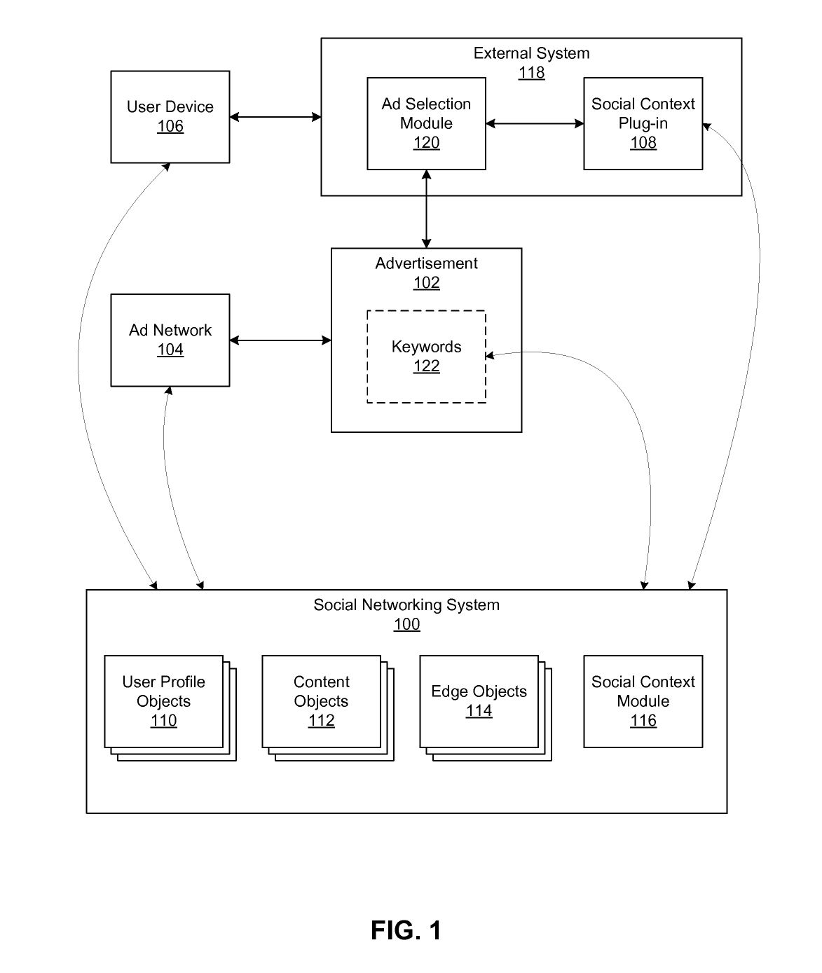

FIG. 1 illustrates a high-level block diagram of a process of providing relevant social context with an advertisement for a viewing user of a social networking system, in one embodiment. A social networking system 100 includes user profile objects 110, content objects 112, and edge objects 114 that may be used by a social context module 116 to determine scores for social context information items relevant to an advertisement 102. In one embodiment, the social networking system 100 is provided with a list of items that are relevant to the advertisement 102, such as identifying information of one or more pages on the social networking system 100 that are relevant to the advertisement 102, one or more pages on an external system 118 that are relevant to the advertisement 102, names of brands included in the advertisement 102, genre of product being advertised in the advertisement 102, and so on. In another embodiment, the social context module 116 may generate the list of items that are relevant to the advertisement 102 based on keywords 122 extracted from the advertisement 102. Topics and keywords may be extracted from the advertisement 102 using methods and tools further described in “Providing Content User Inferred Topics Extracted from Communications in a Social Networking System,” U.S. patent application Ser. No. 13/589,693, filed on Aug. 20, 2012, hereby incorporated by reference. The social context module 116 generates one or more social context information items based on the received or generated list of items that are relevant to the advertisement 102.

An advertisement 102 may include a list of keywords 122 that describe the advertisement 102, in one embodiment. Returning to a previous example, the advertisement 102 may be for a Panasonic LUMIX DMCG2K SLR Digital Camera for sale on Amazon.com. Potential keywords 122 may include “Panasonic,” “SLR,” “Digital Camera,” and “Amazon.com.” A partner may, in another embodiment, provide a list of items for providing social context for a product being advertised in an advertisement 102. The list of items, or keywords, may be provided to the social networking system 100 as appended to a social plugin as installed on the external website serving the advertisement 102, in one embodiment. In another embodiment, the list of keywords may be provided to the social networking system through an application programming interface (API). Determining social context for an item or concept is further described in a related application, “Providing Universal Social Context for Concepts in a Social Networking System,” U.S. patent application Ser. No. 13/295,002 filed on Nov. 11, 2011, which is hereby incorporated by reference.

An ad network 104 may provide an advertisement 102 to an external system 118 for providing to a viewing user operating a user device 106. For example, a viewing user of the social networking system 100 may be viewing a website hosted on an external system 118 that requests an advertisement from an ad network 104. The external system 118 may include an ad selection module 120 and a social context plug-in 108. The social context plug-in 108 may comprise a code snippet of JavaScript, in one embodiment. For example, the social context plug-in 108 may start with a <div> tag that is provided by administrators of the social networking system 100 for inclusion on a website hosted on an external system 118. A social context plug-in 108 may be also defined as an iFrame that may be displayed on a third party site and hosted by the social networking system 100. Social plug-ins are further described in “Personalizing a Web Page Outside of a Social Networking System with Content from the Social Networking System Determined Based on a Universal Social Context Plug-In,” U.S. application Ser. No. 13/563,623 filed on Jul. 31, 2012, which is hereby incorporated by reference. The advertisement 102 may comprise a banner ad, in one embodiment.

FIG. 1 and the other figures use like reference numerals to identify like elements. A letter after a reference numeral, such as “122a,” indicates that the text refers specifically to the element having that particular reference numeral. A reference numeral in the text without a following letter, such as “122,” refers to any or all of the elements in the figures bearing that reference numeral (e.g. “122” in the text refers to reference numerals “122a,” “122b,” and/or “122c” in the figures). Only one object for keywords 122 is shown in FIG. 1 in order to simplify and clarify the description.

The social context plug-in 108 operating on the external system 118 may communicate with the social networking system 100 to receive a selected social context information item for presentation with the advertisement 102. In one embodiment, the social context module 116 receives a request from the social context plug-in 108 for a social context information item, where the request includes the keywords 122 extracted from the advertisement 102. In another embodiment, the keywords 122 are extracted from the advertisement 102 separately by the social context module 116. In a further embodiment, the advertisement 102 is provided to the social networking system 100 by the ad network 104. In yet another embodiment, the ad network 104 requests a social context information item for an advertisement 102 to be displayed on an external system 118 for a viewing user of the social networking system 100 on a user device 106.

In one embodiment, the social networking system may determine one or more keywords 122 for the advertisement based on the content of the third party site and/or known information about the viewing user and other users that have visited the social context plug-in 108 on that site. For example, suppose a third party site for a cooking blog does not include keywords 122 for advertisements. The social networking system 100 may rely on social information in the social networking system 100 to infer keywords for the cooking blog, such as three hundred (300) users that have expressed an interest in cooking on the social networking system 100 have accessed the social context plug-in 108 on the cooking blog site. As a result, the social networking system 100 may determine that “cooking” is a relevant keyword for advertisements on the cooking blog using some level of confidence. The confidence level may be determined by the social networking system 100 based on the users' collective interest in cooking as well as other types of information about the users' interactions with the site, such as posting about food, organic farming, restaurants, and so forth.

The social context module 116 may provide instructions to the social context plug-in on how to overlay the selected social context information item over the advertisement 102, in one embodiment. In another embodiment, the social context module 116 may provide instructions to the social context plug-in on how to present the selected social context information item in conjunction with the advertisement 102, such as by shrinking the display of the advertisement 102 to include the social context information item as text adjacent to the advertisement 102.

The social context module 116 may also provide one or more social context information items to a social context plug-in 108 that has made a request for social context with respect to an advertisement 102. Different types of social context information items may be generated for a user viewing an advertisement. For example, the number of users expressing an interest in a page for an external website selling concert tickets to the local Madonna show may be small, under 400 “likes,” or expressions of interest. If a viewing user of the external website were presented with that number, the user may be discouraged that none of the viewing user's friends on the social networking system are interested in attending the Madonna concert. However, other social context information items may be used to provide a better understanding of the viewing user's interests. A page for Madonna, determined by the social networking system as the page owned by an official entity associated with Madonna, may have a large number of users expressing interest in the band, such as over millions of likes, 200 of which are likes by users connected to the viewing user, and 10 of which are likes by users living near the concert venue. Thus, the 10 users that are connected to the viewing user that have expressed an interest in the musician “Madonna” and that live near the concert venue may be provided in the page for the external website selling concert tickets to Madonna. Those 10 users may have more of an impact on the viewing user if that social context information item is displayed in conjunction with the advertisement for the Madonna concert. The social context module 116 may, in one embodiment, select from the different types of social context information items available for providing to the viewing user in conjunction with an advertisement provided by an ad network 104.

Other social context information items related to the advertisement may also be provided for display in conjunction with the advertisement such as songs recently listened to by other users connected to the user on a music streaming service by Madonna, albums purchased by friends of the user on a digital music website or subscription service, concert reviews posted by other users of the social networking system, and so forth. In one embodiment, social context information comprises selected actions performed by other users of the social networking system connected to a viewing user that are ranked according to relevancy to the page being viewed by the viewing user. As such, actions may be selected as a social context information item for providing for display to the viewing user in conjunction with an advertisement.

In another embodiment, social context information items may be selected by the social context module 116 according to interests of the viewing user using a scoring model that uses the viewing user's affinities for interests relevant to an advertisement as a factor in the model. Social context information may be used to help influence viewing users to click on advertisements by providing an insight into the shared interests of a user's connections. For example, if a viewing user professes an interest in the San Francisco Giants, related actions of other users connected to the user, such as check-in events at AT&T Park in San Francisco, links shared about players on the team, and social gaming applications installed by the other users that are related to fantasy baseball teams, may be selected as a social context information item for display in conjunction with an advertisement for the San Francisco Giants instead of a simpler social context information item that displays the number of connected users that express an interest in the Giants.

The social context module 116 may provide one or more scores for the one or more social context information items provided to the social context plug-in 108. The social context module 116 may rely on various factors to determine scores of social context information items, such as a number of “likes” by connected users of a viewing user, weights selected by the advertiser for social context information items, affinity scores of the viewing user for the social context information items, social opt-out by connected users, and user feedback received about advertisements that have been provided with social context information. In one embodiment, a weighted ordered list of social context information items is provided by the social context module 116 to the social context plug-in 108. In another embodiment, the social context information item with the highest score is provided to the social context plug-in 108 for display to the viewing user in conjunction with the advertisement 102.

In one embodiment, a user device 106 requests an advertisement 102 to be displayed on the user device 106 from an ad network 104 after browsing a page on an external system 118. In this embodiment, the social context plug-in 108 may include instructions for the user device 106 to communicate directly with the social networking system 100 such that the social context module 116 provides the selected social context information item in conjunction with the advertisement 102 displayed on the user device 106. For example, the user device 106 may receive an advertisement 102 from an ad network 104 and may further receive social context information from the social networking system 100. The social context module 116 may provide instructions on how to overlay the social context information over the advertisement 102 received from the ad network 104. In one embodiment, cross-origin resource sharing (CORS) may be used to instruct the browser operating on the user device 106 how to overlay the social context information received from the social networking system 100 over the advertisement 102 received from the ad network 104.

In another embodiment, the social networking system 100 may act as a proxy for the ad server. In this embodiment, the user device 106 may request an advertisement 102 from the social networking system 100 based on browsing a web page on an external system 118 and triggering the social context plug-in 108. Responsive to the request, the social networking system 100 may request the advertisement 102 from the ad network 104 and the social context module 116 may modify the advertisement 102 to render the selected social context information item within the advertisement 102, overlay the social context information item in a pre-defined placement area in the advertisement 102, or shrink the advertisement 102 to display the social context information item adjacent to the advertisement 102. For example, the social context module 116 may select a social context information item for an advertisement 102 for a Panasonic LUMIX DMCG2K SLR Digital Camera for sale on Amazon.com that includes the statement that “Bob and 26 of your friends like Amazon.com.” The advertisement 102 may comprise a banner advertisement such that the statement, or the social context information item, may overlay on the banner advertisement as determined by the social context module 116, in one embodiment. In another embodiment, the advertisement 102 may be a fixed size that may be shrunken by the social context module 116 to provide the statement alongside the advertisement 102.

In a further embodiment, an ad network 104 may partner with the social networking system 100 such that when a user device 106 requests an advertisement 102, the ad network 104 communicates with the social networking system 100 to render relevant social context information in conjunction with the advertisement 102. In this way, the ad network 104 may receive user feedback regarding the social context information and provide different weights for the scoring model. User feedback may include information about whether the user clicked on the ad, clicked on one or more links in the ad, ignored the ad, closed the ad upon pop-up, and so forth. User feedback regarding social context information may include receiving a click on the social context information, in one embodiment. Different weights for the scoring model may be used based on the feedback received. For example, if an advertisement may have three different types of social context information displayed in conjunction with the advertisement, such as number of user likes for a brand page, number of connected users liking the particular product being advertised, and number of likes for a e-commerce page hosting the product being sold, an ad network 104 may utilize the three different types of social context information amongst three groups of users and use user feedback for determining weights for the scoring model for that advertisement.

In one embodiment, the social networking system acts as an ad network 104 by providing advertisements on third party websites or other external systems. Where the ad network 104 comprises the social networking system 100, social context information items may be highly personalized for the viewing user of the advertisement 102 based on real-time user interaction activity in the social networking system 100. For example, a social networking system 100 providing advertisements on a third party application, such as a first mobile application operating on a mobile device, may include social context information relevant to a particular advertisement being provided that may also be customized to the viewing user of the advertisement. The particular advertisement may be timed to be displayed to the viewing user based on various events and interactions in the social networking system 100, such as a connected user installing a second mobile application, where the particular advertisement invites the viewing user to install the second mobile application while the viewing user is operating the first mobile application. Users may be more likely to install applications that their friends and connections on the social networking system 100 are using, so the viewing user may be tempted to install the second mobile application as a result of the social context information received in the advertisement.

The social context plug-in 108 may comprise a social plug-in for displaying content items on an external system 118, in yet another embodiment. The social context plug-in 108 may be configured to enable administrators of the external system 118 to enable advertisements to be served by the social context plug-in 108 in conjunction with relevant social context information. For example, the social context plug-in 108 may be configured to display an advertisement 102 to every fourth viewing user of the social networking system 100 viewing the external system 118.

### System Architecture

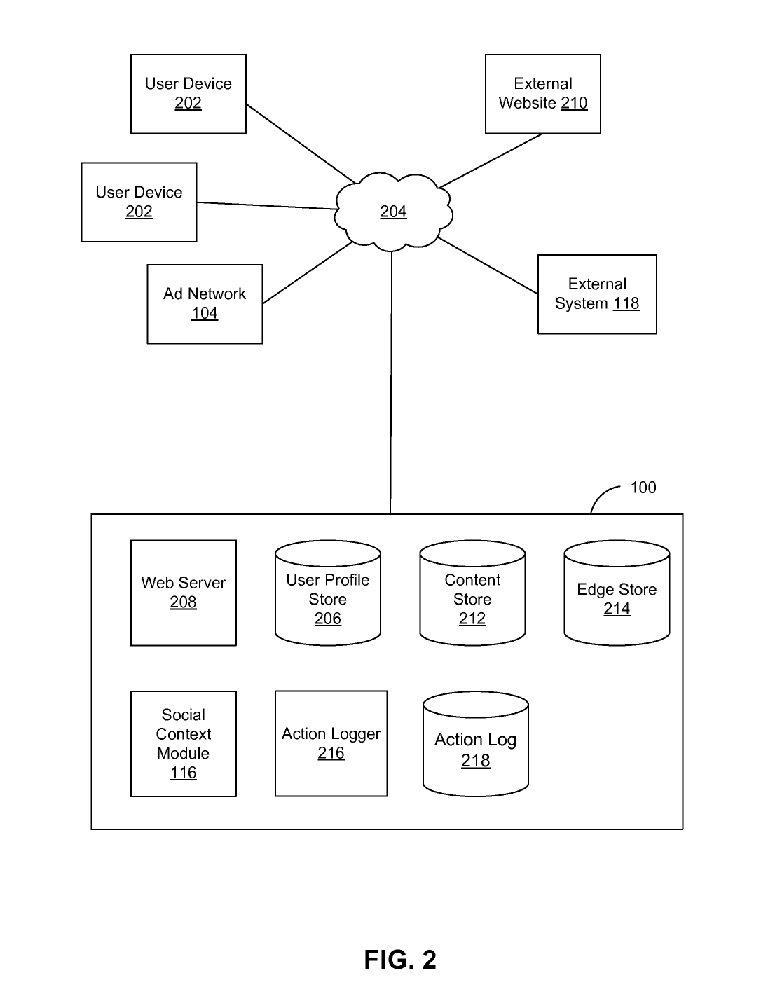

FIG. 2 is a high level block diagram illustrating a system environment suitable for providing social plugins advertisements to users of a social networking system, in accordance with an embodiment of the invention. The system environment comprises one or more user devices 202, the social networking system 100, a network 204, one or more third-party websites 210, an external system 118, and an ad network 104. In alternative configurations, different and/or additional components may be included in the system environment 100. The embodiments described herein can be adapted to online systems that are not social networking systems.

The user devices 202 comprise one or more computing devices capable of receiving user input as well as transmitting and/or receiving data via the network 204. In one embodiment, a user device 202 is a conventional computer system, such as a desktop or laptop computer. In another embodiment, a user device 202 may be a device having computer functionality, such as a personal digital assistant (PDA), mobile telephone, smart-phone or similar device. A user device 202 is configured to communicate via the network 204. In one embodiment, a user device 202 executes an application allowing a user of the user device 202 to interact with the social networking system 100. For example, a user device 202 executes a browser application to enable interaction between the user device 202 and the social networking system 100 via the network 204. In another embodiment, a user device 202 interacts with the social networking system 100 through an application programming interface (API) that runs on the native operating system of the user device 202, such as IOS® or ANDROID™.

The user devices 202 are configured to communicate via the network 204, which may comprise any combination of local area and/or wide area networks, using both wired and wireless communication systems. In one embodiment, the network 204 uses standard communications technologies and/or protocols. Thus, the network 204 may include links using technologies such as Ethernet, 802.11, worldwide interoperability for microwave access (WiMAX), 3G, 4G, CDMA, digital subscriber line (DSL), etc. Similarly, the networking protocols used on the network 204 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over the network 204 may be represented using technologies and/or formats including hypertext markup language (HTML) or extensible markup language (XML). In addition, all or some of links can be encrypted using conventional encryption technologies such as secure sockets layer (SSL), transport layer security (TLS), and Internet Protocol security (IPsec). The third party website 210 may be coupled to the network 120 for communicating with the social networking system 100.

FIG. 2 is an example block diagram of an architecture of the social networking system 100. The social networking system 100 includes a user profile store 206, a content store 212, an action logger 216, an action log 218, an edge store 214, a social context module 116, and a web server 208. In other embodiments, the social networking system 100 may include additional, fewer, or different components for various applications. Conventional components such as network interfaces, security functions, load balancers, failover servers, management and network operations consoles, and the like are not shown so as to not obscure the details of the system architecture.

Each user of the social networking system 100 is associated with a user profile, which is stored in the user profile store 206. A user profile includes declarative information about the user that was explicitly shared by the user, and may also include profile information inferred by the social networking system 100. In one embodiment, a user profile includes multiple data fields, each data field describing one or more attributes of the corresponding user of the social networking system 100. The user profile information stored in user profile store 206 describes the users of the social networking system 100, including biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the social networking system 100 displayed in an image. A user profile, represented as a user profile object 110 in the user profile store 206, may also maintain references to actions by the corresponding user performed on content items in the content store 212 and stored in the action log 218.

While user profiles in the user profile store 206 are frequently associated with individuals, allowing people to interact with each other via the social networking system 100, user profiles may also be stored for entities such as businesses or organizations. This allows an entity to establish a presence on the social networking system 100 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

The content store 212 stores content objects 112 representing various types of content. Examples of content represented by an object include a page post, a status update, a photo, a video, a link, a shared content item, a gaming application achievement, a check-in event at a local business, a brand page, or any other type of content. Objects may be created by users of the social networking system 100, such as status updates, photos tagged by users to be associated with other objects in the social networking system, events, groups or applications. In some embodiments, objects are received from third-party applications or third-party applications separate from the social networking system 100. Content “items” represent single pieces of content that are represented as objects in the social networking system 100. Users of the social networking system 100 are encouraged to communicate with each other by posting text and content items of various types of media through various communication channels, increasing the interaction of users with each other and increasing the frequency with which users interact within the social networking system.

Social networking system users transmit text content to each other using a variety of communication types. The text content is stored in the content store 212 and associated with the user sending the text content and the one or more users receiving the text content. A communication type may be associated with the stored text content. Examples of communication types include status updates, notes, comments, posts and messages. A status update is text data provided by a user that is included in the user's user profile and as stories in news feeds presented to other users connected to the user. Similarly, a note is longer or more detailed text data provided by the user that is included in the user's user profile and as stories in news feeds presented to other users connected to the user. A post is text that a user places on a profile of an additional user connected to the user; a post is typically visible to users connected to the user and/or users connected to the additional user. Comments are data posted based on previously posted content, such as status updates, notes or actions previously taken by a user. Messages are text sent from a user to another user; messages are visible to the user sending the message and the user receiving the message.

Communication types differ from each other in a variety of ways. For example, messages have smaller, more carefully chosen audiences than status updates. As another example, notes are typically longer than other communication types. These differences allow messages having different communication types to provide different information about personality characteristics of users.

The action logger 216 receives communications about user actions on and/or off the social networking system 100, populating the action log 218 with information about user actions. Such actions may include, for example, adding a connection to another user, sending a message to another user, uploading an image, reading a message from another user, viewing content associated with another user, attending an event posted by another user, among others. In some embodiments, the action logger 216 identifies interaction between a social networking system user and a brand page within the social networking system 100, which communicates targeting criteria associated with content on the brand page to a content selector to customize content from the brand page. In addition, a number of actions described in connection with other objects are directed at particular users, so these actions are associated with those users as well. These actions are stored in the action log 218.

The action log 218 may be used by the social networking system 100 to track user actions on the social networking system 100, as well as external website that communicate information to the social networking system 100. Users may interact with various objects on the social networking system 100, including commenting on posts, sharing links, and checking-in to physical locations via a mobile device, accessing content items or other interactions. Information describing these actions is stored in the action log 218. Additional examples of interactions with objects on the social networking system 100 included in the action log 218 include commenting on a photo album, communications between users, becoming a fan of a musician, adding an event to a calendar, joining a groups, becoming a fan of a brand page, creating an event, authorizing an application, using an application and engaging in a transaction. Additionally, the action log 218 records a user's interactions with advertisements on the social networking system 100 as well as other applications operating on the social networking system 100. In some embodiments, data from the action log 218 is used to infer interests or preferences of the user, augmenting the interests included in the user profile and allowing a more complete understanding of user preferences.

The action log 218 may also store user actions taken on external websites. For example, an e-commerce website that primarily sells sporting equipment at bargain prices may recognize a user of a social networking system 100 through social plug-ins that enable the e-commerce website to identify the user of the social networking system 100. Because users of the social networking system 100 are uniquely identifiable, e-commerce websites, such as this sporting equipment retailer, may use the information about these users as they visit their websites. The action log 218 records data about these users, including webpage viewing histories, advertisements that were engaged, purchases made, and other patterns from shopping and buying.

In one embodiment, an edge store 214 stores the information describing connections between users and other objects on the social networking system 100 in edge objects 114. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 100, such as expressing interest in a page on the social networking system, sharing a link with other users of the social networking system, and commenting on posts made by other users of the social networking system.

The edge store 214 stores edge objects 114 that include information about the edge, such as affinity scores for objects, interests, and other users. Affinity scores may be computed by the social networking system 100 over time to approximate a user's affinity for an object, interest, and other users in the social networking system 100 based on the actions performed by the user. A user's affinity may be computed by the social networking system 100 over time to approximate a user's affinity for an object, interest, and other users in the social networking system 100 based on the actions performed by the user. Computation of affinity is further described in U.S. patent application Ser. No. 12/978,265, filed on Dec. 23, 2010, which is hereby incorporated by reference in its entirety. Multiple interactions between a user and a specific object may be stored in one edge object in the edge store 214, in one embodiment. In some embodiments, connections between users may be stored in the user profile store 206, or the user profile store 206 may access the edge store 214 to determine connections between users.

The web server 208 links the social networking system 100 via the network 120 to the one or more user devices 202, as well as to the one or more third party websites 130. The web server 208 serves web pages, as well as other web-related content, such as Java, Flash, XML and so forth. The web server 208 may provide the functionality of receiving and routing messages between the social networking system 100 and the user device 202, for example, instant messages, queued messages (e.g., email), text and SMS (short message service) messages, or messages sent using any other suitable messaging technique. A user may send a request to the web server 208 to upload information, for example, images or videos that are stored in the content store 212. Additionally, the web server 208 may provide API functionality to send data directly to native client device operating systems, such as IOS®, ANDROID™, WEBOS® or RIM.

edge objects 114A social context module 116 may operate in conjunction with other modules of the social networking system 100 to determine one or more social context information items for an advertisement to be provided to a viewing user of the social networking system 100. The social context information item may increase the likelihood that the viewing user clicks on the advertisement. For example, a viewing user may visit a web page on an external website for selling concert tickets to a particular Madonna concert in San Jose, Calif., such as Ticketmaster. The viewing user may be logged into the social networking system 100 while visiting the web page for Madonna concert tickets. After viewing the page, but not purchasing the concert tickets, the viewing user may browse other web pages on other websites. Later, an advertisement 102 may appear on a news service website for the same Madonna concert. The ad network 104 may use a social context plug-in 108 installed on the web page for the news service to include one or more social context information items generated or determined by the social context module 116 for display to the viewing user's user device 106 in conjunction with the advertisement 102 for the Madonna concert. The social context information items may include whether other users are attending the Madonna concert, how many users are interested in the Madonna concert, how many users are interested in Madonna, and how many users connected to the viewing user are interested in Madonna. This social context information may be retrieved from user profiles, content items, and edges in the social networking system 100. In this way, information stored in user profile objects 110 stored in the user profile store 206, content objects 112 stored in the content store 212, and edge objects 114 stored in the edge store 214 may be used by the social context module 116 on the social networking system 100 in determining social context information items for display in conjunction with advertisements provided by one or more ad networks 104 to user devices 202 browsing external systems 118 and/or external websites 210 through a network 204.

A social context plug-in may communicate to a social networking system 100 through a code snippet of JavaScript, iFrame, or other widget using an application programming interface (API). The social context plug-in installed on a third party website may recognize that a viewing user is logged into the social networking system 100 using a cookie installed in the web browser of the user device associated with the viewing user. If the viewing user is not logged into the social networking system 100, the social context plug-in may not render social context information, in one embodiment. In another embodiment, other social context information that is not specific to a viewing user, such as the total number of users that are interested in the Madonna concert, for example, may be presented in conjunction with the advertisement. The plug-in may enable a third party to specify the rules used to render social context with related social objects, how to aggregate the information, and so forth.

The social context plug-in may receive a specified list of objects in the social networking system 100 for determining social context information items, in one embodiment. In another embodiment, the social context plug-in may receive a list of keywords that describe the advertisement being presented to the viewing user. These keywords may be analyzed and matched to corresponding objects in the social networking system 100 based on object properties, such as name, type, and fuzzy matching rules. In a further embodiment, the social networking system 100 may extract keywords and topics from the advertisement to identify corresponding objects in the social networking system 100 for determining social context information items to be presented in conjunction with the advertisement.

### Providing Social Context for Advertisements

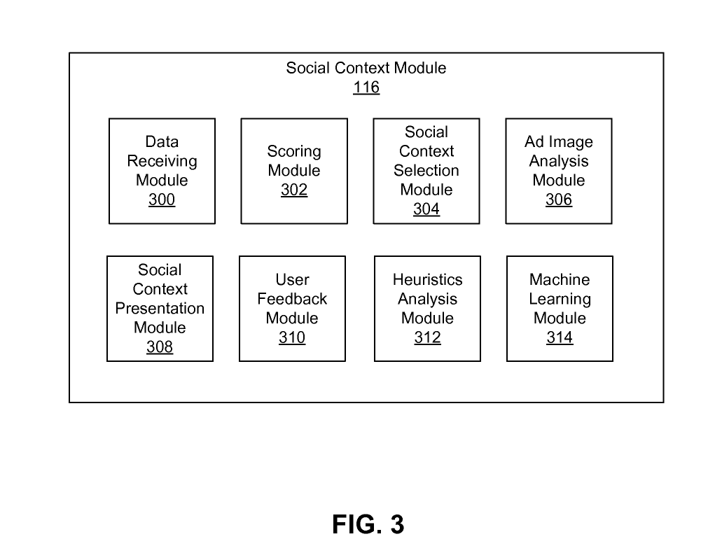

FIG. 3 illustrates a high level block diagram of the social context module 116 in further detail, in one embodiment. The social context module 116 includes a data receiving module 300, a scoring module 302, a social context selection module 304, an ad image analysis module 306, a social context presentation module 308, a user feedback module 310, a heuristics analysis module 312, and a machine learning module 314. These modules may perform in conjunction with each other or independently to develop a match scoring model of matching pages on a social networking system 100.

A data receiving module 300 interfaces with external websites 210, ad networks 104, and external systems 118 to process information about advertisements displayed to users of the social networking system 100. This information may include a listing of keywords, content provided on a third-party website, as well as content included in the advertisement. In one embodiment, the data receiving module 300 may process the information retrieved from external websites 210, ad networks 104, and external systems 118 in a batch process asynchronously from the social context module 116.

A scoring module 302 generates one or more scoring models for scoring social context information items for display in conjunction with advertisements to viewing users of the social networking system 100 on external system 118 and/or external websites 210 as well as the social networking system 100. The scoring module 302 may generate different types of scoring models for determining a score for different types of social context information items that are relevant to an advertisement. Weights, or coefficients, may be assigned to one or more factors in a scoring model such that a particular factor may have more weight than another. The scoring module 302 operates in conjunction with the other modules of the social context module 116 to determine these weights, in one embodiment. In another embodiment, the scoring module 302 selects which factors to use in a particular scoring model for determining one or more scores of relevant social context information items. For example, a list of keywords describing an advertisement may be received by the data receiving module 300, such as “Amazon.com,” “Panasonic,” and “Digital Camera.” As a result, relevant social context information items may be retrieved from user profile objects 110, content objects 112, and edge objects 114 and may be used in determining one or more scores for received list of keywords. A certain keyword, such as “Panasonic,” may be assigned a greater weight by an advertiser such that the score for the keyword may be higher than the scores for the other keywords. However, affinity scores for other keywords and for other users having social context information relevant to other keywords may generate higher scores for those other keywords. In one embodiment, a score of 100% would be determined for a social context information item that is specifically selected by an advertiser for a particular advertisement, such as a social context information item generated by a page on the social networking system 100 relevant to the advertisement.

The scoring module 302 may, in another embodiment, determine one or more scores for a set of relevant social context information items using a scoring model trained on user feedback received from the user feedback module 310 using machine learning methods used by the machine learning module 314 as well as through heuristics about selecting the set of relevant social context information items received from the heuristics analysis module 312, in one embodiment. The selection of relevant social context information items may be manually selected by administrators of the ad network 104, in another embodiment, as received by the data receiving module 300. In a further embodiment, relevant social context information items may be selected for scoring by one or more scoring models based on user feedback received via the user feedback module 310 that affirms or disaffirms a selected relevant social context information item. In yet another embodiment, a combination of received listing of relevant social context information items selected by an ad network as well as other social context information items selected by the social context module 116 may be scored by the one or more scoring models by the scoring module 302.

Different factors may be included in the one or more scoring models used for determining one or more scores for the one or more social context information items for providing to a viewing user of a social networking system 100 in conjunction with an advertisement provided by an ad network 104. Such factors may include, in one embodiment, analyzing attributes of the advertisement, such as genre, concept, and keywords, analyzing attributes of the viewing user, such as web browsing history, affinity scores of interests and connections, and other advertisements clicked upon, as well as analyzing attributes of other users connected to the viewing user. For example, a set of users may be known to influence a particular viewing user, such that when the set of users perform an action or post the action on the social networking system 100 through a communication channel, the viewing user is more likely to interact with the action or post than other user interactions on the social networking system 100. This set of influencing users may be identified in the user profile object 110 of the viewing user, and as a result, social context information received from this set of influencing users that is relevant to the advertisement may be weighted more heavily by the scoring module 302, in one embodiment. Determining a set of influencing users is further described in “Targeting Stories Based on Influencer Scores,” U.S. patent application Ser. No. 13/429,126, filed on Mar. 23, 2012, which is hereby incorporated by reference in its entirety.

A social context selection module 304 may select a particular social context information item for display to a viewing user in conjunction with an advertisement based on the score of the social context information item. The social context selection module 304 may select the highest scoring social context information items for presentation with ads, in one embodiment. In another embodiment, a social context information item may be selected based on regression analysis. A regression model may be used to select social context information items to be provided for display in conjunction with advertisements on external systems 118, in one embodiment. A scoring model may use regression analysis to determine weights for different types of relevant social context information items retrieved for a particular viewing user for a particular advertisement in the scoring model. For example, an initial weight may be assigned to a particular type of social context information item, such as “Amazon.com,” the retailer where the Panasonic SLR Digital Camera is sold. The initial weight may be adjusted up or down based on user feedback received from users affirming or disaffirming the social context information item using regression analysis. Using a combination of the different types of social context information items, the regression model assigns a coefficient to each of the types of social context information items based on user feedback and probability of receiving positive feedback, such as a click-through of the advertisement.

In one embodiment, regression analysis may be used to determine a score that indicates whether a type of social context information is a good fit with the particular advertisement for the particular viewing user. This “fit” test may be based on other types of social context information already selected to be used for the particular advertisement for the particular viewing user. A curve fit, or best fit, yields a number from 0 to 1 that can be used as an accuracy measurement of the selection of the particular type of social context information. Regression analysis, in one embodiment, may also be used to adapt the scoring model to include or exclude different types of social context information that are determined to be relevant or not relevant to a particular advertisement for a particular viewing user based on machine learning techniques and heuristics analysis of the information retrieved about the advertisement, the viewing user, and other users connected to the viewing user on the social networking system 100.

An ad image analysis module 306 may be used to analyze advertisements received by the social context module 116 in a plurality of ways. In one embodiment, the ad image analysis module 306 may extract one or more keywords from an advertisement to determine relevant social context information items for the advertisement. In another embodiment, the ad image analysis module 306 may determine one or more high contrast regions and one or more low contrast regions in the advertisement for determining placement of social context information as text within the advertisement. High contrast regions may indicate that text and/or images may be displayed in the regions, where low contrast regions, such as regions that include blank space or less crowded regions, may be selected for placing the social context information in conjunction with the advertisement. Other information about the advertisement may be analyzed by the ad image module 306 for use by the social context presentation module 308, such as color, resolution, size, shape, and other formatting information.

A social context presentation module 308 generates one or more display options for providing social context information items for display in conjunction with an advertisement for to display to a viewing user of the social networking system 100 on an external system 118 or on the social networking system 100. In one embodiment, the social context presentation module 308 may determine that the display of the advertisement be shrunk by a determined percentage in order to display the selected social context information item adjacent to the advertisement. In another embodiment, the social context presentation module 308 may determine that the selected social context information item may be displayed as an overlay over the advertisement. The overlay may be placed in a particular region of the advertisement as determined by the ad image analysis module 306, in one embodiment. In another embodiment, the placement of the overlay may be received from the ad network 104 providing the advertisement to the viewing user on the external system 118 or on the social networking system 100.

A user feedback module 310 may receive user feedback regarding advertisements that provide social context information in conjunction with the display of the advertisements, such as whether the viewing user clicked-through the advertisement, whether the viewing user completed a purchase based on the advertisement, whether the viewing user provided negative feedback on the advertisement, and a comparison of the click-through rate of the advertisement in aggregate without the social context information and with the added social context information. In one embodiment, the user feedback module 310 may provide a user interface for the viewing user to provide more detailed feedback, such as providing selectable links associated with different levels of feedback, providing a text input field for receiving text from the viewing user, and so forth.

A heuristics analysis module 312 operates independently and asynchronously from the other modules in the social context module 116. The heuristics analysis module 312 performs various steps to gather information from the social networking system 100. For example, an action log includes actions that users perform on the social networking system. The heuristics analysis module 312 may be used to analyze the level of communications activity on the social networking system to determine whether those communications include certain keywords, such as “Justin Bieber,” that may indicate a topic of the communication activity. Using these heuristics, relevant social context information items comprising the communication activity may be retrieved for a particular advertisement for display to a particular viewing user.

A machine learning module 314 may be used in the social context module 116 to refine one or more scoring models defined in the scoring module 302. In one embodiment, a social networking system 100 uses a machine learning algorithm to analyze user feedback received from the user feedback module 310 to retrain the scoring model. The scoring model may be refined to include more or less factors for determining the score of social context information items selected for advertisements, and the weights assigned to each factor, or coefficients, may also be adjusted based upon the user feedback. In another embodiment, a thumbs up/down algorithm for receiving user feedback may be used to retrain the scoring model. The thumbs up/down algorithm is further described in “User Feedback-Based Selection and Prioritizing of Online Advertisements,” U.S. patent application Ser. No. 12/611,874, filed on Nov. 3, 2009, which is hereby incorporated by reference in its entirety.

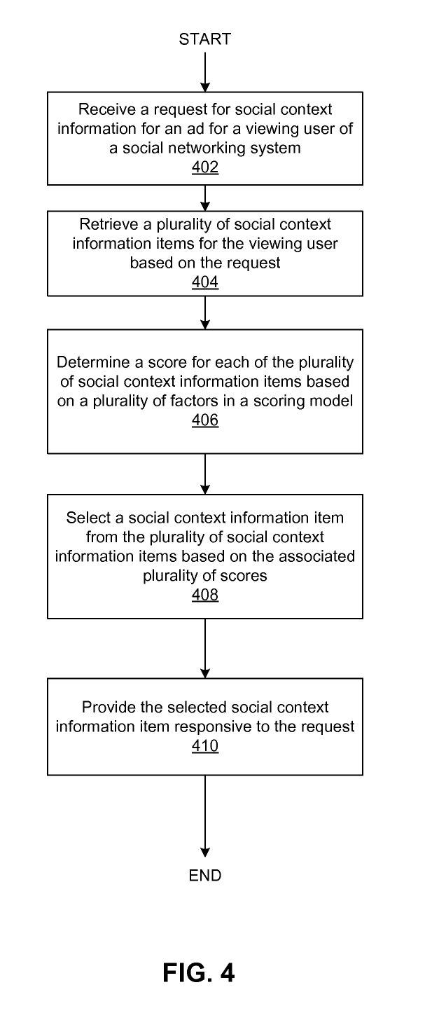

FIG. 4 illustrates a flow chart diagram depicting a process of providing social context within an advertisement for a viewing user of a social networking system, in accordance with an embodiment of the invention. A request for social context information for an ad is received 402 for a viewing user of a social networking system. The request for social context information for an ad may be received 402 from a social context plug-in installed on an external system or external website, in one embodiment. The request for social context information for an ad may be received 402 from an ad network, in another embodiment. In yet another embodiment, the request for social context information for an ad may be received by an ad server on the social networking system 100 providing the ad on a page on the social networking system 100. The request may include identifying information of one or more objects in the social networking system 100 relevant to the advertisement, in one embodiment. In another embodiment, the request may include information items that may be used by the social networking system 100 to identify one or more objects in the social networking system 100 that are relevant to the advertisement, such as a listing of keywords. In a further embodiment, the request may include a link, referral, or other identifying information of a page where the social ad may displayed so that the social networking system may analyze the page and extract topics and/or keywords for the page to determine objects for retrieving social context information items relevant to the advertisement.

Next, a plurality of social context information items is retrieved 404 for the viewing user based on the request. The plurality of social context information items may be retrieved 404 based on a list of selected items relevant to the advertisement received from the ad network, in one embodiment. The plurality of social context information items may be retrieved 404 based on a list of content objects in the social networking system 100 determined to be relevant to the advertisement from an analysis of the advertisement by the social networking system 100, in another embodiment. In a further embodiment, the plurality of social context information items may be retrieved 404 from the social networking system 100 based on a previously determined listing of the plurality of social context information items for the advertisement.

After a plurality of social context information is retrieved 404 for the viewing user, a score for each of the plurality of social context information items is determined 406 based on a plurality of factors in a scoring model. Scores may be generated by one or more scoring models for the plurality of social context information items, where each social context information item is scored by a scoring model to generate a score. For example, a score may be generated for a particular brand of digital camera being advertised, a type of social context information item for the ad, based on a scoring model for determining the efficacy of that type of social context information item on influencing the particular viewing user to click on the advertisement. A score for the social context information item of how many users expressed interest the particular brand of digital camera being advertised may be lower than a score for the social context information item of how many users expressed interest in the retailer that is advertising the camera based on weights selected by the advertiser as well as weights determined using machine learning techniques. An advertiser may heavily weight social context information items related to retailers versus brands of camera, for example. As a result, scores for social context information items related to retailers may be higher than scores for social context information items related to digital camera brands. However, a certain brand, such as Panasonic, may be specifically weighted more than retailers based on user feedback received from users clicking on advertisements with social context information related to the Panasonic brand. As a result, social context information items related to Panasonic may score higher than social context information items related to retailers. In one embodiment, one scoring model may be used for generating scores for all types of social context information items for the advertisement. In another embodiment, different scoring models may be used that include different factors based on information retrieved about a viewing user, other users connected to the viewing user on the social networking system 100, and the advertisement.

After the plurality of scores are generated for the plurality of social context information items, a social context information item is selected 408 from the plurality of social context information items based on the associated plurality of scores. The selected social context information item may be the social context information item with the highest score, in one embodiment. In another embodiment, the selected social context information item may be an item having a score greater than a predetermined threshold for scores. In yet another embodiment, more than one social context information items may be selected 408 for display based on the associated plurality of scores meeting or exceeding a predetermined threshold. For example, the social context plug-in may select which of the multiple social context information items may be provided in conjunction with the advertisement for display to the viewing user. As another example, more than one social context information items may be provided for display to the viewing user in conjunction with the advertisement.

The selected social context information item is then provided 410 responsive to the request. The selected social context information item may be provided 410 responsive to an application programming interface (API) request, in one embodiment. As a result, the selected social context information item may be provided 410 through the same API. In another embodiment, the selected social context information item is provided 410 to a social context plug-in installed on an external system or external website on which the advertisement is being displayed to the viewing user of the social networking system 100. In a further embodiment, the selected social context information is provided 410 to the ad server of the social networking system 100 for providing the selected social context information item in conjunction with an advertisement provided for display on a page of the social networking system 100.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving a request for social context information for an advertisement for a viewing user of a social networking system, where the request identifies one or more objects in the social networking system related to the advertisement;
retrieving a plurality of social context information items for the viewing user based on the one or more relevant items about the advertisement, wherein each of the retrieved social context information items relates to an action performed in connection with another user with whom the viewing user is connected and to an object identified by the request;
determining a score for each of the plurality of social context information items based on a plurality of factors in a scoring model;
selecting a social context information item from the plurality of social context information items based on the associated plurality of scores; and
providing the selected social context information item responsive to the request.

2. The method of claim 1, wherein receiving a request for social context information for an advertisement further comprises:
receiving an application programming interface (API) call from a widget embedded in an external website associated with the page, the API call including the request for social context information for the advertisement.

3. The method of claim 1, wherein retrieving a plurality of social context information items for the viewing user based on the one or more relevant items about the advertisement further comprises:
identifying one or more actions performed by other users of the social networking system connected to the viewing user;
aggregating the one or more actions performed by the other users by action type; and
determining the plurality of social context information items for the viewing user based on the aggregated actions.

4. The method of claim 1, wherein retrieving a plurality of social context information items for the viewing user based on the one or more relevant items about the advertisement further comprises:
identifying one or more actions performed by other users of the social networking system connected to the viewing user;
ranking the actions performed by the other users by relevance to the advertisement;
selecting a plurality of high-ranking actions meeting a predetermined threshold; and
determining a social context information item of the plurality of social context information items for the advertisement based on the plurality of high-ranking actions.

5. The method of claim 1, wherein retrieving a plurality of social context information items for the viewing user based on the one or more relevant items about the advertisement further comprises:
identifying one or more actions performed by other users of the social networking system connected to the viewing user;
ranking the actions performed by the other users by affinity to the viewing user; and
determining a social context information item of the plurality of social context information items based on the ranked actions.

6. The method of claim 1, wherein providing the selected social context information item responsive to the request further comprises:
rendering the selected social context information item in conjunction with the advertisement.

7. The method of claim 1, wherein providing the selected social context information item responsive to the request further comprises:
rendering the selected social context information item as an overlay on the advertisement.

8. The method of claim 1, wherein providing the selected social context information item responsive to the request further comprises:
rendering the selected social context information item adjacent to the advertisement for display to the viewing user.

9. A method comprising:
receiving a request to provide an advertisement to a viewing user of a social networking system, where the request includes identifying information about one or more objects in the social networking system;
determining one or more social context information items for display to the viewing user in conjunction with the advertisement, where the one or more social context information items are determined based on the identifying information about the one or more objects in the social networking system;
determining one or more regions within the advertisement for placing the one or more social context information items for display to the viewing user in conjunction with the advertisement; and
providing the one or more social context information items for display in one of the determined one or more regions within the advertisement.

10. The method of claim 9, wherein determining one or more social context information items for display to the viewing user in conjunction with the advertisement further comprises:
retrieving user profile information about the viewing user from the social networking system;
determining one or more relevant items about the advertisement in view of the retrieved user profile information about the viewing user and the identifying information about the one or more objects in the social networking system; and
determining the one or more social context information items based on the determined one or more relevant items about the advertisement and the retrieved user profile information about the viewing user.

11. The method of claim 9, wherein determining one or more social context information items for display to the viewing user in conjunction with the advertisement further comprises:
retrieving user interaction information about the viewing user with one or more content objects associated with the advertisement from the social networking system;
determining one or more relevant items about the advertisement in view of the retrieved user interaction information about the viewing user and the identifying information about the one or more objects in the social networking system; and
determining the one or more social context information items based on the determined one or more relevant items about the advertisement and the retrieved user interaction information about the viewing user.

12. The method of claim 9, wherein determining one or more social context information items for display to the viewing user in conjunction with the advertisement further comprises:
retrieving edge object information associated with the advertisement from the social networking system in relation to the viewing user;
determining one or more relevant items about the advertisement in view of the retrieved edge object information and the identifying information about the one or more objects in the social networking system; and
determining the one or more social context information items based on the determined one or more relevant items about the advertisement and the retrieved edge object information associated with the advertisement.

13. The method of claim 9, wherein determining one or more regions within the advertisement for placing the one or more social context information items for display to the viewing user in conjunction with the advertisement further comprises:
identifying one or more low contrast regions within the advertisement based on an analysis of one or more images in the advertisement; and
determining the one or more regions within the advertisement for placing the one or more social context information items as the identified one or more low contrast regions.

14. The method of claim 9, wherein providing the one or more social context information items for display in one of the determined one or more regions within the advertisement further comprises:
rendering the one or more social context information items as an overlay over the determined one or more regions within the advertisement.

15. A method comprising:
receiving a request for one or more social context information items for display in conjunction with an advertisement to a viewing user of a social networking system, where the request includes one or more information items for identifying one or more objects in the social networking system relevant to the advertisement;
determining one or more relevant items about the advertisement based in part on retrieved information about the viewing user and the one or more information items for identifying one or more objects in the social networking system relevant to the advertisement;
retrieving a plurality of social context information items for the viewing user based on the determined one or more relevant items about the advertisement;
selecting a social context information item from the plurality of social context information items; and
providing the selected social context information item for display in conjunction with the advertisement responsive to the request.

16. The method of claim 15, wherein receiving a request for one or more social context information items further comprises:
receiving the request from a social plug-in installed on an external website, where the request includes identifying information about the viewing user.

17. The method of claim 15, wherein receiving a request for one or more social context information items further comprises:
receiving the request from a social plug-in installed on an external website, where the request includes one or more keywords extracted from the advertisement.

18. The method of claim 15, wherein receiving a request for one or more social context information items further comprises:
receiving the request from an ad network providing the advertisement on an external website, where the request includes one or more keywords about the advertisement.

19. The method of claim 15, wherein the request includes one or more keywords about the advertisement and wherein determining one or more relevant items about the advertisement further comprises:
determining the one or more relevant items about the advertisement further based on the one or more keywords about the advertisement.

20. The method of claim 15, wherein determining one or more relevant items about the advertisement further comprises:
extracting one or more keywords from the advertisement;
retrieving one or more edge objects 114 from the social networking system associated with the viewing user based on the extracted one or more keywords; and
determining the one or more relevant items about the advertisement based on the retrieved one or more edge objects 114.

21. The method of claim 15, wherein determining one or more relevant items about the advertisement further comprises:
extracting one or more keywords from the advertisement;
retrieving one or more content objects from the social networking system associated with the viewing user based on the extracted one or more keywords; and
determining the one or more relevant items about the advertisement based on the retrieved one or more content objects.

22. The method of claim 15, wherein retrieving a plurality of social context information items for the viewing user based on the determined one or more relevant items about the advertisement further comprises:
retrieving one or more content objects from the social networking system associated with the viewing user based on the determined one or more relevant items about the advertisement; and
determining the plurality of social context information items based on the retrieved one or more content objects.

23. The method of claim 15, wherein retrieving a plurality of social context information items for the viewing user based on the determined one or more relevant items about the advertisement further comprises:
retrieving one or more user interactions with one or more content objects from the social networking system associated with the viewing user based on the determined one or more relevant items about the advertisement; and
determining the plurality of social context information items based on the retrieved one or more user interactions.

24. The method of claim 15, wherein selecting a social context information item from the plurality of social context information items further comprises:
retrieving a scoring model for determining a plurality of scores for the plurality of social context information items, where the scoring model includes a plurality of factors and a plurality of weights for different types of social context information items;
retrieving information about the viewing user based on the plurality of factors included in the retrieved scoring model;
determining the plurality of scores for the plurality of social context information items using the retrieved scoring model based on the retrieved information about the viewing user; and
determining a selected social context information item of the plurality of social context information items based on the determined plurality of scores.
